(19) United States
(12) Patent Application Publication
(10) Pub. No.: US 2006/0071747 A1
(43) Pub. Date: Apr. 6, 2006

(54) Method for manufacturing superconducting coils

(75) Inventors: Alexander Friedman, Tel Aviv (IL); Shuki Wolfus, Kiryat-Ono (IL); Yosef Yeshurun, Ganei Tikvah (IL); Zvi Bar-Haim, En Harod Ihud (IL)

Correspondence Address: BROWDY AND NEIMARK, P.L.L.C.;624 NINTH STREET, NW, SUITE 300, WASHINGTON, DC, 20001-5303, US

(73) Assignees: Bar Ilan University, Ramat Gan (IL); RICOR Cryogenic & Vacuum Systems, En Harod Ihud (IL)

(21) Appl. No.: 11/239,380

(22) Filed: Sep. 30, 2005

Related U.S. Application Data
(60) Provisional application No. 60/615,028, filed on Oct. 4, 2004.

(51) Int. Cl. H01F 6/00

(52) U.S. Cl. 335/216

(57) ABSTRACT

A superconducting coil having form of pancake or double pancake wound of non-insulated superconducting wire (tape) with insulating layer between adjacent turns composed of epoxy resin filled with ceramic powder of high thermal conductivity. A superconducting coil composed of several pancakes and/or double pancakes and includes layers of said epoxy with or without additional spacers between adjacent pancakes. Pancakes or double pancakes as well as coils, consisting of several pancakes and/or double pancakes that have a solenoid form or racetrack or saddle forms.

### FIELD OF THE INVENTION

This invention relates to a method for manufacturing superconducting coils, particularly resin impregnated high-temperature superconducting (HTS) coils.

### BACKGROUND OF THE INVENTION

High-temperature superconducting (HTS) coils are commonly manufactured in two different ways: “wind and react” and “react and wind”. EP 0 772 208 in the name of Hitachi published May 7, 1997 and entitled “Oxide-superconducting coil and a method for manufacturing the same” discloses a superconducting coil formed using the “wind and react” method which requires the following sequence of operations: insulating the wire with temperature-resistive insulating tape, for example glass-fiber tape, winding the coil, thermal treating the coil, vacuum resin impregnating, and curing the resin.

The “react and wind” method includes the following sequence of operations; insulating the wire with normal tape, for example kapton tape, winding the coil, resin impregnation, and curing the resin. Resin impregnation may be carried out by ‘wet winding’ or by vacuum impregnation. In wet winding, the resin is simply brushed into each layer during the winding process. During vacuum impregnation, the complete coil is placed in a mould leaving a minimum void around the coil. It is often convenient to make the coil former an integral part of the mould. The complete mould assembly is then placed in a vacuum tank where it is evacuated; heat may be applied to drive off moisture and assist the outgassing process. After a good vacuum (˜0.1 Torr) is achieved, resin is admitted to the mould. Resin flow is monitored to ascertain the point at which the mould is full and the ingress of resin ceases. Atmospheric pressure may then be applied to drive resin into the last nook and cranny. Finally, the mould assembly is heated in an oven to cure the resin. The coil made with ‘wet winding’ can be also heated to cure the resin or a cold-cured resin can be used.

Both methods require insulated superconducting wire. The insulation process is a costly operation that increases the cost of the superconducting wire by 10-15%.

Another drawback of both the above prior art methods is a reduced thermal conductivity of the coil having layers of electrical insulation with low thermal conductivity between turns. This drawback has a strong deleterious effect in conduction-cooled coils. Low thermal conductivity increases cooling time and decreases heat removal during operation thus worsening coil stability.

FIG. 1 is a cross-sectional view showing a fragment of a prior art pancake coil. 10 formed of HTS wire 11. A ‘pancake’ coil is one wherein multiple turns of wire are wound one on top of the other so as to form a planar coil in the form of a spiral that, when viewed from the plane of the spiral, has a height equal to that of a single turn of wire and a radius that increases as more turns of wire are wound. When used for superconducting coils, the wire is of rectangular cross-section as shown in FIG. 1. Thus, FIG. 1 shows in cross-section two turns of wire denoted respectively by 11 and 11a. The wire is insulated with a surrounding layer of insulation 12 and successive turns of wire are separated by a thin layer of resin 13 formed during impregnation, which hardens to bond adjacent layers, or turns, and form a solid structure.

### SUMMARY OF THE INVENTION

Accordingly, one object of the present invention is to provide a structure of a superconducting (HTS) coil with improved thermal conductivity in order to solve the aforementioned problems.

Another object of the present invention is to provide a method for manufacturing a superconducting coil as above with non-insulated superconducting wire to decrease the cost of the coil. The method according to the invention also enables achieving higher current density of the coil than is achieved using prior art methods by reducing the distance between turns therefore increasing the filling factor of the coil.

The superconducting coil according to the present invention is made with non-insulated superconducting wire by the ‘wet winding’ method. The resin used in the process is an epoxy, preferably having low viscosity, filled with high thermal conductivity electrically insulating powder. The sieve composition of the powder and filling factor of the epoxy are selected in such a way that (i) the necessary distance between adjacent coil turns ensures sufficient insulation properties; (ii) higher thermal conductivity of the coil is achieved; and (iii) the capacity between adjacent layers meets the desirable design characteristics.

The filling powder may be selected from high thermal conductivity ceramic powders as alumina, boron nitride etc. Typical maximal size of the particles is 10-50 μm depending on the required distance between adjacent turns. Several powder fractions can be mixed together to ensure high filling factor of the epoxy and thus its high thermal conductivity. The coil is wound in the form of pancakes or double pancakes stacked together. The space between pancakes is also filled in the same manner with resin mixed with ceramic particles. The coil may consist of at least one pancake or double pancake and has the form of a solenoid, racetrack or saddle.

A method for manufacturing a superconducting pancake coil with non-insulated wire comprises:

preparing a bath of a resin containing a predetermined percent of ceramic powder;

wet winding the pancake coil while wetting all surfaces of the wire to be wound by said resin;

winding with a velocity and wire tension to ensure the minimal thickness of resin layer;

removing excess resin from the pancake coil;

assembling the coil with a given number of pancakes such that a space between pancakes includes a layer of said filled resin, the thickness of the layer being defined by the pressure applied while assembling,

curing the coil at conditions suitable for the used resin.

When manufacturing a saddle coil, additional operations of half-curing the pancakes and forming saddle-shaped pancakes are necessary prior to assembling the coil.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a cross-sectional view showing a fragment of a prior art coil mad of HTS tape;

FIG. 2 is a cross-sectional view showing a fragment of a coil made of HTS tape according to the present invention;

FIG. 3 presents a coil consisting of three pancakes having an intermediate space filled with the epoxy containing ceramic particles; and

FIGS. 4a and 4b are cross-sectional views showing schematically a coil according to the present invention having a saddle-shaped form according to different embodiments of the invention.

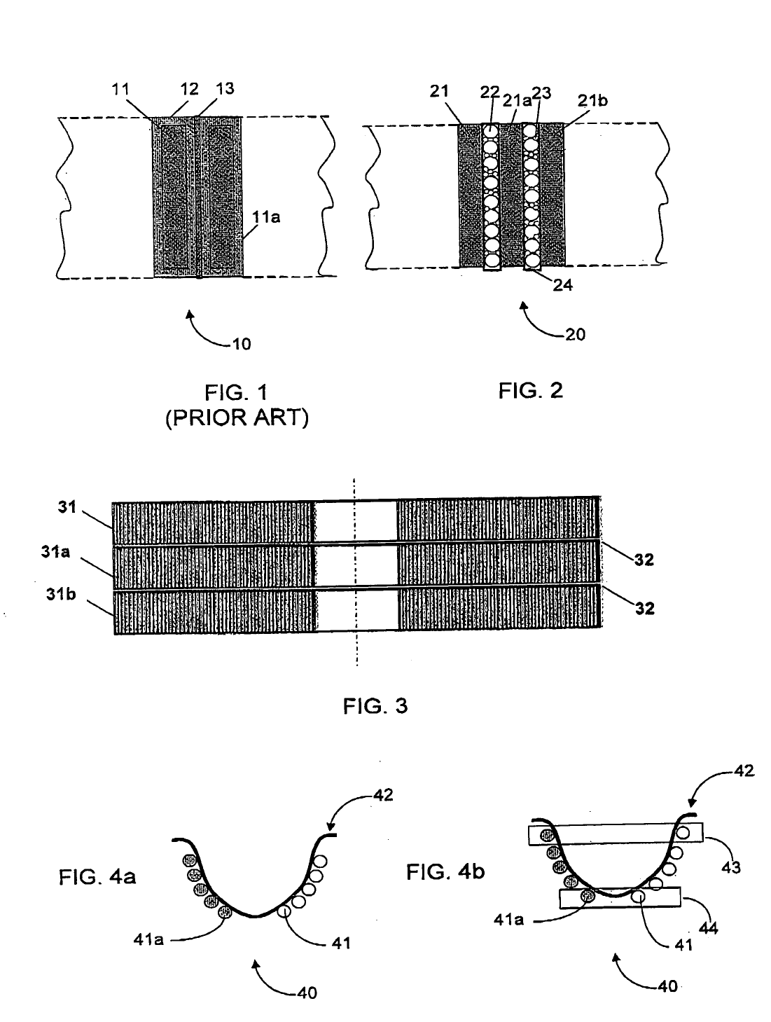

### DETAILED DESCRIPTION OF EXEMPLARY EMBODIMENTS

FIG. 2 is the cross-sectional view showing a fragment of a pancake coil 20 in accordance with the present invention employing non-insulated turns of wire 21, 21a and 21b. Resin layers 24 with embedded large 22 and small 23 ceramic insulating particles with high thermal conductivity separate the non-insulated wires 21, 21a and 21b. The size of the large particles 22 defines the distance between adjacent turns and thus the filling factor of the coil. The small particles 23 fill the space between the large particles and between the large particles and the HTS wires. High filling factor of the resin ensures a high thermal conductivity of the whole coil in the radial direction.

Suitable materials for the superconducting wire are BSCCO, YBCO or MgB tapes

FIG. 3 shows the cross-section of a coil, in accordance with the present invention, comprising several pancakes 31 all having the above-described structure as shown in FIG. 2. The pancakes 31 are separated by layers 32 of a ceramic-particles filled-epoxy similar to the filled epoxy used for the pancakes winding. In another case, to ensure the possibility for disassembling the coil, wax can be used instead of epoxy, filled with the same ceramic powder for insulation between pancakes.

FIGS. 4a and 4b are cross-sectional views showing schematically a coil 40 according to the present invention having a saddle-shaped form according to different embodiments of the invention. As shown in FIG. 4a, the coil 40 comprises multiple turns of wire, such as the turn shown as 41, which is spiral wound a saddle shaped core 42. The wire turn 41 appears on, the opposite side of the core as 41a, such that each wire turn comprises the two half-tuns shown respectively on opposite sides of the core as 41 (clear) and 41a (shaded). In FIG. 4a, the complete coil is formed by winding a single length of wire around the core 41 so as to form successive turns as shown.

FIG. 4b shows a similar configuration but where adjacent turns of wire are each formed as a separate pancake coil of which two (non-adjacent) such pancakes are shown as 43 and 44 and are formed as described above with reference to FIG. 2. In such an arrangement, multiple pancakes are stacked one on top of the other and bonded using ceramic-particles filled-epoxy similar to the filled epoxy used for the pancakes winding.

A method for manufacturing the saddle-shaped superconducting coil shown in FIG. 4b, comprises:

preparing a bath of a resin containing a given percent of ceramic powder;

wet winding a pancake coil while wetting all surfaces of the superconducting wire by said resin;

winding with velocity and wire tension that ensure a minimal thickness of resin layer;

removing excess resin from the pancake;

half-curing the pancakes, so that pancakes acquire a strength without loss of plasticity;

forming saddle-shaped pancakes;

assembling the coil with a required number of pancakes with or without additional gauze spacers between pancakes, the space between pancakes having a layer of said filled epoxy, the thickness of the layer being defined by the pressure applied during coil assembly; and

final curing the coil at conditions suitable for the used resin.

1. A superconducting coil wound from non-insulated superconducting wire (tape) with insulating layer between adjacent turns composed of epoxy resin, filled with ceramic powder of high thermal conductivity.

2. The superconducting coil in accordance with claim 1, wherein said epoxy has low viscosity during winding process so that coil turns are spaced apart at the distance equal to maximal grain size of the said ceramic powder.

3. The superconducting coil in accordance with claim 2, wherein the maximal grain size of said ceramic powder is several percents of the tape thickness ensuring a high filling factor of the said superconducting coil.

4. The superconducting coil in accordance with claim 1, wherein said ceramic powder contains particles of two or more sizes, these sizes being selected in a way that the epoxy filling factor is high.

5. The superconducting coil in accordance with claim 1, wherein said ceramic is powder is alumina.

6. The superconducting coil in accordance with claim 1, wherein said ceramic powder is boron nitride.

7. The superconducting coil in accordance with claim 1, wherein said super-conducting coil has the form of pancake or double pancake.

8. The superconducting coil in accordance with claim 7, wherein said pancakes have a form of racetrack.

9. The superconducting coil in accordance with claim 7, wherein said pancakes have a saddle-shaped form.

10. The superconducting coil in accordance with claim 1, wherein said super-conducting wire includes an oxide superconductor.

11. The superconducting coil in accordance with claim 10, wherein said super-conducting wire is BSCCO tape.

12. The superconducting coil in accordance with claim 10, wherein said super-conducting wire is YBCO tape.

13. The superconducting coil in accordance with claim 10, wherein said super-conducting wire is MgB tape.

14. A superconducting coil comprising at least two pancakes and/or double pancakes according to claim 8 having a common axis wherein said pancakes and/or double pancakes are separated by a layer of epoxy resin, filled-with ceramic powder of high thermal conductivity and having low thickness with or without additional spacer.

15. The superconducting coil in accordance with claim 14, wherein said pancakes have a form of racetrack.

16. The superconducting coil in accordance with claim 14, wherein said pancakes have a saddle-shaped form.

17. A method for manufacturing a superconducting coil with non-insulated wire, said superconducting coil comprising at least two pancakes and/or double pancakes having a common axis wherein said pancakes and/or double pancakes are separated by a layer of epoxy resin, filled with ceramic powder of high thermal conductivity and having low thickness with or without additional space, the method comprising:
preparing a bath of a resin containing a given percent of ceramic powder;
wet winding the pancakes while wetting all surfaces of the superconducting wire by said resin;
winding with velocity and wire tension that ensure a minimal thickness of resin layer;
removing excess resin from the pancake;
assembling the coil with a required number of pancakes with or without additional gauze spacers between pancakes, the space between pancakes having a layer of said filled epoxy, the thickness of the layer being defined by the pressure applied during coil assembly; and
curing the coil at conditions suitable for the used resin.

18. The method according to claim 17, wherein said space between pancakes has a layer of wax filled with ceramic powder.

19. A method for manufacturing a saddle-shaped superconducting coil comprising at least two saddle-shaped coils formed of pancakes and/or double pancakes having a common axis wherein said pancakes and/or double pancakes are separated by a layer of epoxy resin, filled with ceramic powder of high thermal conductivity and having low thickness with or without additional space, the method comprising:
preparing a bath of a resin containing a given percent of ceramic powder;
wet winding the pancakes while wetting all surfaces of the superconducting wire by said resin;
winding with velocity and wire tension that ensure a minimal thickness of resin layer;
removing excess resin from the pancake;
half-curing the pancakes, so that the pancakes acquire a strength without loss of plasticity;
forming saddle-shaped coils;
assembling the coil with a required number of pancakes with or without additional gauze spacers between pancakes, the space between pancakes having a layer of said filled epoxy, the thickness of the layer being defined by the pressure applied during coil assembly; and
final curing the coil at conditions suitable for the used resin.

20. The method according to claim 19, wherein said space between pancakes has a layer of wax filled with ceramic powder.
